(19) United States
(12) Patent Application Publication
(10) Pub. No.: US 2003/0164026 A1
(43) Pub. Date: Sep. 4, 2003

(54) Processing and interface method for ion sense-based combustion monitor

(76) Inventors: Robert W. Koseluk, Carmel, IN (US); Raymond O. Butler JR., Anderson, IN (US); Philip Allen Karau, Grand Blanc, MI (US); Ronald J. Kiess, Decatur, IN (US)

Correspondence Address: MARGARET A. DOBROWITSKY, DELPHI TECHNOLOGIES, INC., Mail Code: 480-414-420, Legal Staff, P.O. Box 5052, Troy, MI, 48007-5052, US

(21) Appl. No.: 10/091,312

(22) Filed: Mar. 4, 2002

(51) Int. Cl. G01L 23/22

(52) U.S. Cl. 73/35.08

(57) ABSTRACT

An apparatus for detecting a combustion condition, such as knock or misfire, includes an incremental integrator in proximity with an ignition coil and provides a stream of digital pulses to a remote control unit, such as an engine control unit. The incremental integrator includes an integration device, such as a capacitor, a threshold comparator, and a pulse generator. A charging current proportional to an ion current charges the capacitor to a preset level wherein the threshold comparator changes state, causing the pulse generator to generate a pulse. The pulse is provided to the control unit, which may include a counter for counting the stream of pulses. The generated pulse also is fed back to reset the integration device, for example discharge of the capacitor. The process is repeated during a condition window, such as a knock window or a combustion window. The count held in the counter of the control unit is indicative of the level of combustion or knock, as applicable. The control unit may further include an adaptive threshold which is used, in connection with the count and the counter, to produce a difference signal, which is used for spark control.

### BACKGROUND OF THE INVENTION

1. Technical Field

The invention relates generally to a system for controlling ignition in an internal combustion engine, and, more particularly, to an ion sense-based combustion monitor.

2. Description of the Related Art

One approach for detecting a combustion condition, such as knock or misfire, involves the use of a so-called ion sense system. It is known that the combustion of an air/fuel mixture in an engine results in molecules in the cylinder being ionized. It is further known to apply a relatively high voltage across, for example, the electrodes of a spark plug just after the ignition operation to produce a current between the electrodes. Such current is known as an ion current. The ion current that flows is proportional to the number of combustion ions present in the area of, for example, the spark plug gap referred to above, and is consequently provides some measure of the ionization throughout the entire cylinder as combustion occurs. The DC level or amount of ion current is indicative of the quality of the combustion event, or whether in fact combustion has occurred at all (e.g., a misfire condition). An AC component of the ion current may be processed to determine the presence of knock. The ion sense approach is effective for any number of cylinder engines and various engine speed and load combinations.

For example, U.S. Pat. No. 5, 534,781 issued to Lee et al. entitled “COMBUSTION DETECTION VIA IONIZATION CURRENT SENSING FOR A ‘COIL-ON-PLUG’ IGNITION SYSTEM” discloses ion sense system of the type described above having a sense voltage source and an integrator wherein the integrator develops an analog output that is an integrated version of an ion current signal. This analog output is provided to an electronic control unit. The location of the ion sense circuits, the method of signal processing, and the type of interface to the electronic control unit all affect the accuracy of the ion current measurement. The relatively low level of the ion current and a relatively high level of electromagnetic interference (EMI) in an engine compartment make it desirable to locate ion current measuring circuits as close to the spark plug and ignition coil as possible. Another analog system is shown in U.S. Pat. No. 5,425,339 issued to Fukui, which disclose an ion sense system having a peak detector that measures the peak ion signal that occurs between a reset pulse and the sample time of a sampling A/D converter in the electronic control unit. The analog systems described above, however, have shortcomings.

First, the accuracy of the analog output may be reduced by the presence of EMI in the engine compartment and wiring harness. The analog interface, either before or after the integrator or peak detector, may be corrupted by such interference. Expensive shielding techniques may be required to achieve a desired level of accuracy. Second, such an analog output is not generated in real-time. Thus, the analog output is not valid until the end of a measuring interval; therefore, the electronic control unit would be unable to mask any interference contributions that may occur near the start or end of the measuring interval. Such contributions again may reduce the accuracy of the output.

One approach taken in the art in an attempt to overcome the foregoing problems with analog systems involves use of a digital interface between the ion sensing system and the electronic control unit, as seen by reference to U.S. Pat. No. 5,694,900 issued to Morita et al. entitled “KNOCK CONTROL SYSTEM FOR AN INTERNAL COMBUSTION ENGINE.” Morita et al. disclose that an ionic current flowing through an ignited spark plug is band pass filtered to extract engine knock frequency components (i.e., a filtered knock signal). A comparator outputs a low digital signal when the filtered knock signal exceeds a predetermined threshold signal. The comparator output is provided from the ion sense system to the electronic control unit. The output is a sequence of pulses corresponding to peaks of the filtered knock signal. The digital pulses provide improved noise immunity compared to an analog signal. The electronic control unit of Morita et al. includes a counter that counts the knock pulses and a lowpass filter that develops a background signal using the pulse count. A knock controller decides the amount of delay (i.e., delay or retard of ignition timing) based on a difference signal between the pulse count and the background signal. The system of Morita et al., however, has several shortcomings. First, the response of the comparator to knock and background noise is nonlinear in that knock and background levels below the threshold, in general, produce no output pulses. The absence of pulses makes determining the background level by way of a low pass filter (as disclosed in Morita et al.) inaccurate. The foregoing described nonlinearity is aggravated by the fact that the relation between the knock intensity and the number of knock pulses is dependent on the shape of the knock signal envelope. Another disadvantage is the low resolution of the pulse count, which is limited by the number of knock oscillation cycles during the time window (i.e., the window signal which is gated with the stream of pulse output from the comparator). Yet another disadvantage is the difficulty in setting the threshold level that was used by the comparator of Morita et al. While Morita et al. do not disclose how such threshold is determined, even a look up table indexed by engine speed and load (1) would add cost and complexity to the ion sense function, (2) would be time consuming to calibrate, and (3) would not adapt to changes in fuel formulation.

There is therefore a need to provide an apparatus for detecting a combustion condition, such as a knock or misfire condition, that minimizes or eliminates one or more of the shortcomings as set forth above.

### SUMMARY OF THE INVENTION

One object of the present invention is to provide a solution to one or more of the above-identified problems. One advantage of the present invention is that it provides an EMI tolerant digital interface that does not require expensive shielded wiring. Second, an apparatus according to the present invention provides output pulses in real-time, such that an electronic control unit or the like may mask an interference contribution that may occur near the start or end of a measuring interval. Third, the invention measures background and light knock at levels much lower than possible with the prior art, allowing a more accurate estimate of the background level and detection of lower knock levels. Additionally, the number of digital output pulses according to the invention is not limited to the number of knock oscillation cycles in the measuring interval, as is the prior art, but rather, corresponds to a number that may be made increased by selection of an integrator threshold and integration time constant in an incremental integrator according to the invention. Finally, an apparatus according to the invention does not have a threshold that requires calibration. The improved accuracy of the estimate of a background level achieved with this invention adapts to engine operating conditions as well as changes in fuel formulation.

A method according to the invention is provided for determining a combustion condition in a cylinder, and includes the step of generating an ion current signal corresponding to an ionization level in the cylinder. A second step of the method involves producing a pulse based on an integrated ion current signal configured for incrementing a counter wherein a count in the counter corresponds to the combustion condition. In a knock detection embodiment, the method includes the further steps of filtering the ion current signal using a bandpass filter, rectifying the filtered ion current signal, and gating the filtered and rectified ion current signal using a knock window. In a still further embodiment, the count may be used to develop a background signal used in producing a difference signal for spark control.

In another aspect of the invention, an apparatus is provided for determining a combustion condition, and which includes a measuring circuit and an incremental integrator. The measuring circuit is provided for generating an ion current signal corresponding to an ionization level in the cylinder. The incremental integrator is responsive to the ion current signal and is provided for producing a signal configured to increment or advance a counter wherein a count in the counter corresponds to the combustion condition. In a preferred embodiment of the apparatus, the incremental integrator includes an integrating device, a comparator, and a pulse generator. The integrating device is responsive to the ion current signal and is configured to produce an output signal that corresponds to an integrated version of the ion current signal. The comparator is configured to compare the output of the integrating device with a threshold signal. The comparator has an output terminal for generating a trigger signal when the integrated ion current signal exceeds the threshold signal. The pulse generator is responsive to the trigger signal and is configured to produce a pulse, which is in turn configured to update the counter. In a still further preferred embodiment, the incremental integrator includes means responsive to the pulse that is configured to reset the integrating device.

Other objects, features, and advantages of the present invention will become apparent to one skilled in the art from the following detailed description and accompanying drawings illustrating features of this invention by way of example, but not by way of limitation.

### BRIEF DESCRIPTION OF THE DRAWINGS

FIG. 1 is a simplified block diagram of an ion sense system according to the invention.

FIG. 2 is a simplified block diagram showing, in greater detail, a processing/interface circuit according to the invention.

FIG. 3 comprises timing diagrams of various signals generated during the operation of the system of FIG. 1.

FIG. 4 is a simplified block diagram of an alternate embodiment according to the invention having a gated input to a counter in an electronic control unit.

FIG. 5 is a simplified block diagram of an apparatus configured to detect knock and misfire via incremental integration.

### DETAILED DESCRIPTION OF THE PREFERRED EMBODIMENTS

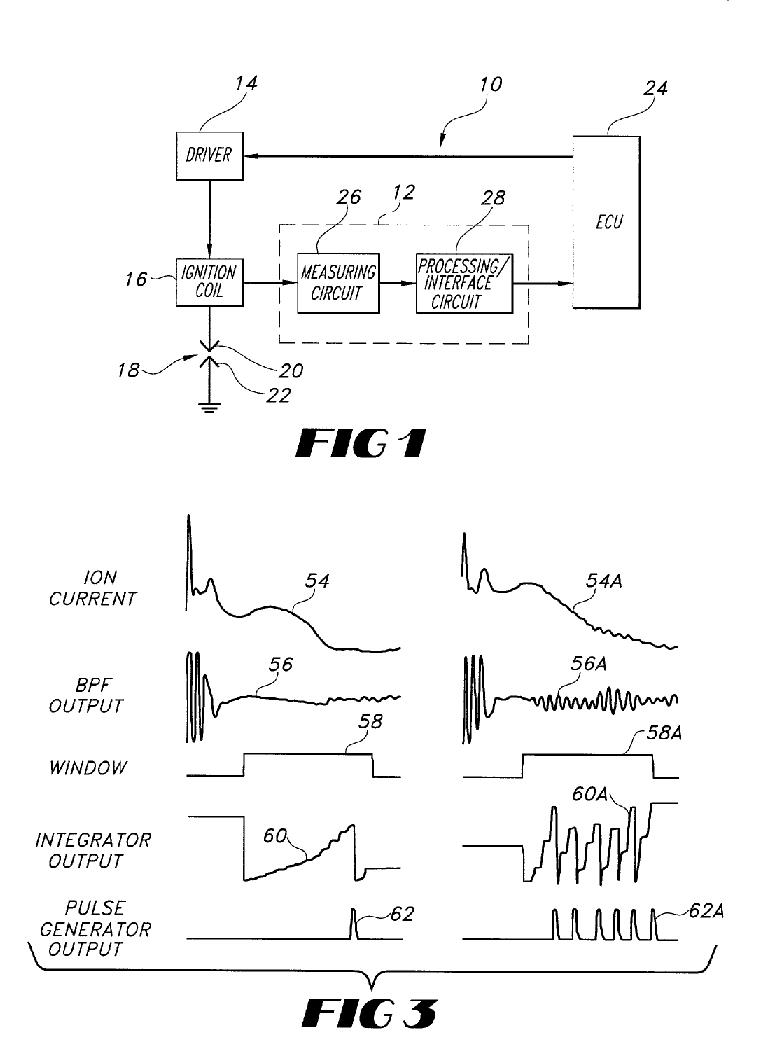

Referring now to the drawings wherein like reference numerals are used to identify identical components in the various views, FIG. 1 shows an ignition system 10 having ion sense system 12 in accordance with the present invention. FIG. 1 further shows a driver 14, an ignition coil 16, a spark plug 18 having spaced electrodes 20, 22, and an electronic control unit (ECU) 24. Ion sense system 12 is shown including a measuring circuit 26 and a processing/interface circuit 28.

The coil 16, including the associated components ion sense system 12 and driver 14, are adapted for installation to a conventional internal combustion engine by way of spark plug 18 in threaded engagement with a spark plug opening into a combustion cylinder. Spark timing (dwell control) and the like is provided by control unit 24. The engine may be of the type having a direct ignition system for initiating combustion. In the illustrated embodiment, one ignition coil is provided per spark plug. Although not shown, control unit 24 may also control, in addition to spark, fuel delivery, air control and the like. In a global sense, control unit 16 may be configured to control the overall combustion event.

With continued reference to FIG. 1, electrodes 20, 22 of plug 18 are disposed into cylinders of an internal combustion engine to allow for sensing of ionization resulting from the burning of an air/fuel mixture. The invention is not limited, however, to spark ignition engines with suitable electrodes, combustion in a diesel engine can be sensed, processed, and interfaced using the invention. In a spark ignition engine, the spark plug electrodes 20, 22 allow ready access for ionization sensing. Control unit 24 provides an ignition timing signal to driver 14 which, when at a high level, stores energy in ignition coil 16. When the timing signal returns to a low level, a high voltage is generated across a gap defined by spaced electrodes 20, 22, as known in the art. Ion sense system 12, comprising measuring circuit 26 and a processing/interface circuit 28, is configured to be connected to one of either the high or low side of a secondary winding (not shown) of ignition coil 16. Measuring circuit 26 provides isolation from ignition transients, a voltage bias for biasing the gap defined by electrodes 20, 22, and further provides an ion current-to-voltage converter function. These functions are known to those of ordinary skill in the art, for example, as set forth in U.S. Pat. No. 6,186,129 entitled “ION SENSE BIASING CIRCUIT” issued to Butler, hereby incorporated by reference or in U.S. Pat. No. 5,534,781 issued to Lee et al., referred to in the Background, hereby incorporated by reference.

Processing/interface circuit 28 is configured, generally, to convert a measured ion current signal into a digital output that can be utilized by control unit 24 to assess the combustion event and determine a combustion condition (e.g., misfire and/or knock). For example, the magnitude of a DC component of the ion current is indicative of a combustion condition, such as combustion, and/or misfire. The greater the ion current (i.e., due to more ionized molecules present in the cylinder), the more complete the combustion. In addition, the magnitude of an AC component of the ion current is indicative of a knock condition. A first knock mode may be defined based on the magnitude of the AC component of the ion current in a range between approximately 5-6 kHz. A second knock mode may be defined based on the magnitude of the AC component of the ion current in a range between approximately 10-12 kHz. According to the invention, the foregoing determination of the respective DC and AC component magnitudes may be determined during a so-called combustion window and a knock window, respectively. The starting and ending times, as well as duration, of each window is important in accurately determining a misfire condition and/or a knock condition, as more fully developed below.

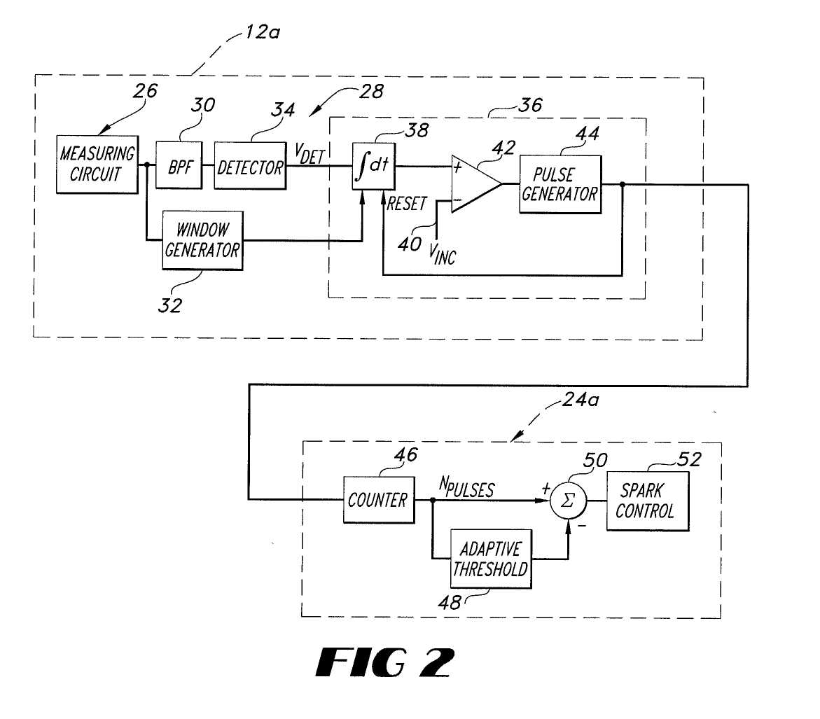

FIG. 2 shows, in greater detail, a first embodiment of the ion sense system shown in FIG. 1, designated an ion sense system 12a, as well as a first embodiment of control unit 24, designated control unit 24a. Ion sense system 12a is shown including measuring circuit 26, and processing/interface circuit 28. Circuit 28 may include a bandpass filter 30, a window generator 32, a detector 34, and an incremental integrator 36 comprising an integration device 38, a threshold voltage V_{INC} on line 40 supplied to a threshold comparator 42, and a pulse generator 44. Control unit 24a is shown including a counter 46, an adaptive threshold circuit 48, a summer circuit 50, and a spark control unit 52.

In the illustration, the system 12a is configured to detect a knock condition. The ion sense system 12a supplies a digital output to control unit 24a. This digital interface overcomes the shortcoming of analog systems, particularly with respect to noise immunity. The output of measuring circuit 26, namely an ion current signal, is bandpass filtered by filter circuit 30 to extract predetermined knock frequency components, such components being described above. The output of filter 30 is either half-wave or full-wave rectified by detector 34, producing an output signal designated V_{DET}, which is in turn supplied to incremental integrator 36. Window generator 32 develops a coarse time window over the approximate interval that knock may be expected to occur. For example, this window may be developed as a function of engine position (e.g., opening up about 10-15° past top dead center). Strategies for determining a knock window are known.

Integration device 38 integrates the signal V_{DET} from detector 34 while the output from window generator 32 is asserted (e.g., in a preferred embodiment, at a high level). Since the output of detector 34, namely V_{DET}, is greater than or equal to zero, the output of integration device 38 is monotonically increasing with time. The output of the integration device 38 is provided to a non-inverting input of comparator 42. Comparator 42 compares the level of the output from the integration device 38 with a threshold voltage signal V_{INC}. When the output of the integration device 38 exceeds the threshold voltage V_{INC}, the comparator 42 output transitions from, in the illustrated embodiment, a low to a high level. This transition causes pulse generator 44 to produce a single, short duration pulse. The output of pulse generator 44 may be fed back to integration device 38 to reset the integrator to a zero output level. The foregoing defines one increment of integration of the detected ion current signal. Following the reset pulse, the integration process resumes, and additional increments of integration may occur for the duration of the time window generated by window generator 32.

Control unit 24a counts the pulses from ion sense system 12a in counter 46 and develops an adaptive threshold by way of adaptive threshold circuit 48 from the pulse count particularly as it is being updated as a function of time. The pulse count, designated N_{PULSES} is compared to the adaptive threshold level using a summer 50, which outputs a difference signal. The difference signal is supplied to spark control 52.

The spark control unit 52 may use the information (i.e., the difference signal) extracted from such analysis to make adjustments in the control of spark in order to improve combustion and/or abate knock. The art is replete with strategies for analyzing knock and minimizing/eliminating its occurrence, and spark control unit 52 may employ such conventional strategies or otherwise use the difference signal in its algorithms.

The number of pulses N_{PULSES} produced by pulse generator 44 during the coarse window is approximated by the following equation:

$${N}_{PULSES} = INT [ \frac{\int {V}_{DET} ⅆ t}{τ {V}_{INC}} ]$$

where:

INT[x] is the largest integer less than or equal to x

V_{DET} is the ion current signal from detector 34

V_{INC} is the integrator threshold voltage

τ is the integration time constant

It should be noted that in the foregoing equation, the parameter V_{INC} defines the increment of integration, and that the number of pulses N_{PULSES} represents the number of integration increments developed by the ion current signal. It should be further appreciated that the measurement gain may be effectively increased (i.e., to increase N_{PULSES}) by reducing the integration time constant τ or by reducing the integrator threshold voltage V_{INC}.

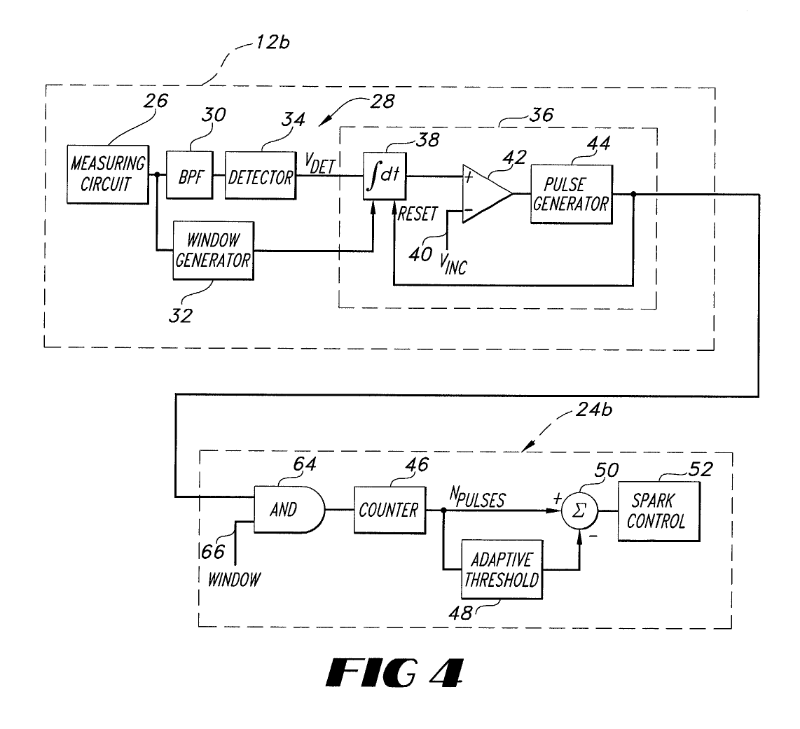

FIG. 3 shows a number of timing diagrams generated during the operation of the circuit shown in FIG. 2. In particular, trace 54 shows the ion current signal for a non-knocking combustion condition, while trace 54A shows the ion current signal for a knocking combustion condition. Trace 56 shows the bandpass filter output for a non-knocking combustion condition, while trace 56A shows the bandpass filter output for a knocking combustion condition. Trace 58 shows the window signal for a non-knocking combustion condition, while trace 58A shows the window signal for a knocking combustion condition. The trace 60 shows the integration device output for a non-knocking combustion condition, while trace 60A shows the integration device output for a knocking combustion condition. Trace 62 shows the pulse generator output for a non-knocking combustion condition, while trace 62A shows the pulse generator output for a knocking combustion condition.

For a non-knocking combustion condition, the output of the integration device 38, shown in trace 60, increases monotonically during the time window with the background signal and crosses the voltage threshold level V_{INC} near the end of the window 58, creating a single output pulse in trace 62.

For a knocking combustion condition, however, the knock oscillations shown in trace 56A cause the output of the integration device 38, shown in trace 60A, to increase at a faster rate, resulting in six (i.e., exemplary number only) output pulses in trace 62A during the time window 58A. Under different knocking conditions (or different integration time constant or integrator threshold), the number of pulses may be significantly larger. The single pulse in trace 62 may be used in establishing a background signal, with the trace 62A indicating knock, and from which a difference signal (e.g., five pulses) may be developed and used by spark control unit 52.

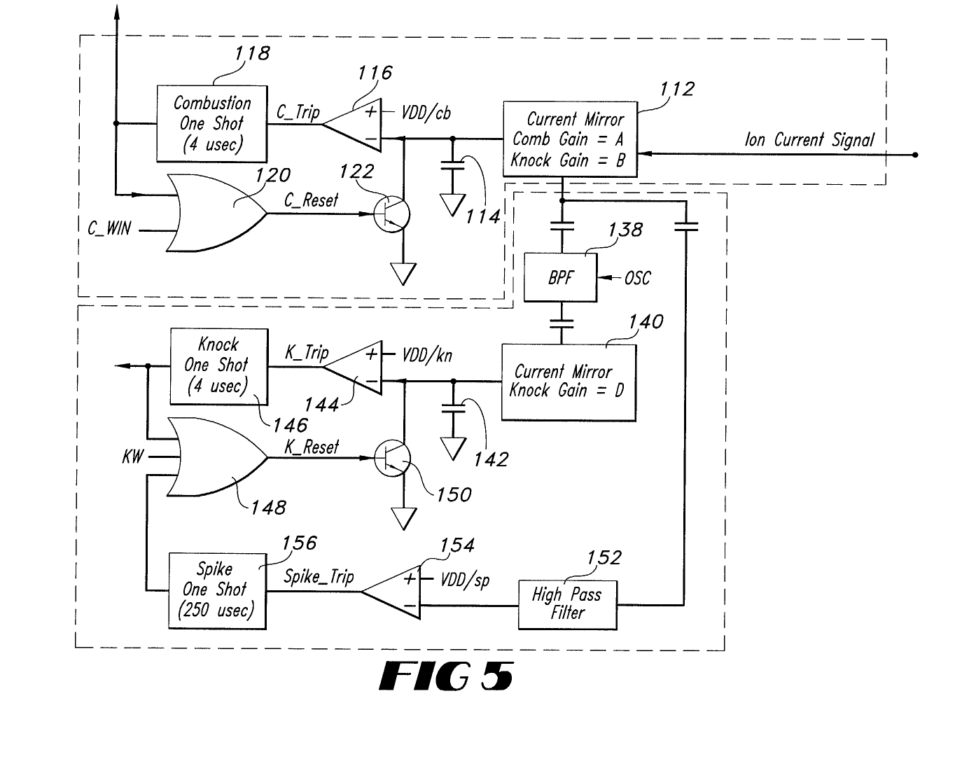

FIG. 4 shows a second embodiment of the present invention, designated ion sense system 12b, as well as a control unit 24b. The embodiment shown in FIG. 4 is substantially identical to that shown in FIG. 2, except for an additional ECU time window signal on line 66 fed to a masking AND logic gate 64 within the control unit 24b. Specifically, the window generator 32 in the ion sense system provides a coarse window for enabling the incremental integrator 36. In some cases, however, interference signals near the start or end of this window may result in undesirable output pulses. A more refined time window, for example, may be available in the electronic control unit, and may be used to mask or gate off these unwanted pulses. This action is possible only because the pulses from pulse generator 44 occur in real time. Otherwise, the ECU's frame of reference regarding timing would not apply, as for example when the pulses are not in real time as for the analog systems described in the Background. This additional structure and function is shown in FIG. 4.

It should be further understood that the foregoing system and methods may be applied identically to convey combustion information, for example, misfire information, to the electronic control unit 24. In such case, the bandpass filter 30, and detector 34 would be omitted, thereby allowing incremental integrator 36 to integrate the ion current signal from measuring circuit 26 directly. In such alternate embodiment, the pulses provided by pulse generator 44 would correspond in number to the degree or level of combustion (or lack thereof) in the cylinder, as detected by a DC level of ion current.

FIG. 5 shows an embodiment for realizing an apparatus according to the invention configured to detect both misfire and knock. Specifically, FIG. 5 shows an incremental integrator for determining a combustion signal that comprises a current mirror 112, a capacitor 114, a comparator 116, a combustion one shot circuit 118, a logical OR gate 120, and a switch such as transistor 122. Current mirror 112 generates a current that corresponds to a DC component of the ion current (conditioned by the first gain factor). When capacitor 114 has been charged so that the voltage impressed thereon exceeds a combustion threshold on the non-inverting input of comparator 116 (i.e., the VDD/cb signal), the output of the comparator (i.e., the C_TRIP signal) changes state on account of the voltage build up on the inverting input of comparator 116. A pulse is therefore generated at the output of one shot 118 responsive to the state change of comparator 116. A combustion window signal C_WIN is applied to OR gate 120. The combustion window signal goes low when processing is to be enabled.

During combustion processing, both inputs to OR gate 120 are initially a logic low, which maintains the transistor 122 in a non-conductive state, which in turn allows current mirror 112 to charge integrating capacitor 114. However, when the one shot circuit 118 generates a pulse, which in the illustrated embodiment is a low-to-high-to-low pulse, gate 120 outputs a logic high signal, which turns on transistor 122, which in turn discharges the integrating capacitor 114. The one shot pulse from circuit 118 is also provided to ECU 24. The stream of pulses which ensue as a result of the incremental integration are applied to counter 46. The stream of pulses operate to increment the counter. The count held in the counter corresponds to the integrated ion current signal, and further, indicative of the level of combustion (and/or misfire).

FIG. 5 also shows an apparatus for detecting knock via incremental integration. Bandpass filter 138 is used for passing an AC component of the ion current for further processing, in a frequency range for example, as described above. Current mirror 140 produces a charging current on an output thereof destined for charging capacitor 142. The components 142, 144, 146, 148, and 150 operate to incrementally integrate the selected AC component of the ion current in substantially the same manner as described above in connection with the incremental integration of a combustion signal. However, an OR GATE 148 includes, in addition to a knock window (KW) signal input, another input signal produced by a spike one shot circuit 156. The components 152, 154, and 156 produce a positive output pulse, which in turn causes transistor 150 to conduct, thereby preventing capacitor 142 from being charged, when switching spikes or the like are present in the ion current signal. The charging/discharging cycle of capacitor 142 is repeated for the duration of the knock window wherein knock one shot 146 produces a stream of pulses that are received by a counter such as counter 46 in the ECU. The count may be processed as described above.

The invention overcomes the disadvantages of both the analog and digital interface systems of the prior art. Relative to the prior art systems described in the Background, this invention provides an improved EMI tolerant digital interface that does not require expensive shielded wiring. The incremental integrator according to the invention provides output pulses in real-time, such that a control unit or the like may mask any interference contributions that may occur near the start or end of the measuring interval.

In addition, relative to the other prior art systems, the invention measures background and light knock at levels much lower than possible with conventional systems, allowing a more accurate estimate of the background level and detection of lower knock levels. The number of digital output pulses is not limited to the number of knock oscillation cycles and the measuring interval, rather, the number may be made larger by suitable selection of the integrator threshold and integration time constant in the incremental integrator. The incremental integrator accomodates the large dynamic range between light and heavy knock, without saturation, simply by providing the requisite range in the digital counter. Finally, this invention does not have a threshold that requires calibration. A more accurate estimate of the background level is achieved with this invention, which inherently adapts to engine operating condition changes as well as changes in fuel formulation, for example.

It is to be understood that the above description is merely exemplary rather than limiting in nature, the invention being limited only by the appended claims. Various modifications and changes may be made thereto by one of ordinary skill in the art which embody the principles of the invention and fall within the spirit and scope thereof.

1. A method of determining a combustion condition in a cylinder comprising the steps of:
(A) generating an ion current signal corresponding to an ionization level in the cylinder; and
(B) producing a pulse based on an integrated ion current signal for incrementing a counter wherein a count in the counter corresponds to said combustion condition.

2. The method of claim 1 further including the step of:
integrating the ion current signal to produce the integrated ion current signal;
producing the pulse when the integrated ion current signal exceeds a threshold level;
resetting the integrated ion current signal.

3. The method of claim 2 further including the step of:
incrementing the counter responsive to the pulse.

4. The method of claim 1 wherein said generating step includes the substep of:
generating the ion current signal during a condition window selected from the group comprising one of a combustion window or a knock window.

5. The method of claim 4 wherein said condition window comprises the knock window, and said generating the ion current signal step includes the substeps of:
filtering the ion current signal according to a bandpass filter;
rectifying the filtered ion current signal; and
gating the filtered and rectified ion current signal using the knock window.

6. The method of claim 5 further including the steps of:
integrating the gated, rectified and filtered ion current signal to produce an integrated ion current signal;
producing a pulse when the integrated ion current signal reached a predetermined level;
updating the counter responsive to the pulse; and
resetting the integrated ion current signal.

7. The method of claim 6 wherein said integrating step comprises the substeps of:
charging a capacitor using a charging current proportional to the gated, rectified and filtered ion current signal.

8. The method of claim 6 wherein said step of producing a pulse comprises the substeps of:
comparing the integrated ion current signal with a threshold signal;
generating a trigger signal when the integrated ion current signal exceed said threshold signal; and
providing the trigger signal to a pulse generator having an output terminal configured to produce said pulse.

9. The method of claim 6 wherein said step of resetting includes the substeps of:
discharging the capacitor.

10. The method of claim 6 wherein said integrating, producing and resetting steps are repeated for the duration of the knock window so as to integrate the detected ion current signal wherein the count in the counter corresponds to the knock signal.

11. The method of claim 10 wherein said step of updating said counter includes positively incrementing the then-existing count in the counter.

12. An apparatus for determining a combustion condition comprising:
a measuring circuit for generating an ion current signal corresponding to an ionization level in the cylinder; and
an incremental integrator responsive to said ion current signal for producing a signal configured to update a counter wherein a count in said counter corresponds to said combustion condition.

13. The apparatus of claim 12 wherein said incremental integrator comprises:
an integrating device responsive to said ion current signal configured to produce an output signal corresponding to an integrated version of said ion current signal;
a comparator configured to compare said output signal with a threshold signal, said comparator having an output terminal for generating a trigger signal;
a pulse generator responsive to said trigger signal configured to produce a pulse, said pulse being configured to update the counter.

14. The apparatus of claim 13 further including a means responsive to said pulse configured to reset said integrating device.

15. The apparatus of claim 14 wherein said integrating device is a capacitor, said reset means comprising a switch coupled to discharge said capacitor.

16. The apparatus of claim 15 further including a bandpass filter responsive to said ion current signal configured to pass an AC component of said ion current signal in a preselected bandwidth;
a detector coupled to said filter configured to rectify said AC component of said ion current signal;
a window generator responsive to said ion current signal for producing a knock window signal.

17. The apparatus of claim 16 wherein said integrating device includes a gate for gating said rectified AC component of said ion current signal with said knock window signal.

18. The apparatus of claim 16 further including a spike detector circuit.

19. The apparatus of claim 16 wherein said spike detector circuit includes a high-pass filter, a spike comparator, and a spike one-shot.

20. A method of determining a combustion condition in a cylinder comprising the steps of:
(A) generating an ion current signal corresponding to an ionization level in the cylinder;
(B) integrating an input signal corresponding to said ion current signal to produce an output signal;
(C) producing a pulse when said output signal exceeds a threshold signal
(D) updating a counter responsive to said pulse wherein a count in the counter corresponds to a combustion condition; and
(E) resetting the output signal using the pulse.

21. The method of claim 20 further including the step of repeating said generating, integrating, producing, updating and resetting steps during one of a combustion window or a knock window.

22. The method of claim 21 further including the steps of comparing the count in the counter with a second threshold signal to thereby develop a difference signal, and adjusting one of spark timing and fuel delivery parameters as a function of the difference signal.

23. The method of claim 22 wherein said second threshold is adaptive based on at least the count in the counter.

24. The method of claim 23 wherein said pulses are gated according to a refined window produced by an engine control unit.
